(19) United States
(12) Patent Application Publication
(10) Pub. No.: US 2006/0248619 A1
(43) Pub. Date: Nov. 2, 2006

(54) Method of preparing silver nano-structure by means of scanning turnneling microscopy

(76) Inventor: Daisuke Fujita, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 10/529,760

(22) PCT Filed: Sep. 18, 2003
(86) PCT No.: PCT/JP03/11914

§ 371 Date: Sep. 16, 2005

(30) Foreign Application Priority Data
Sep. 30, 2002 (JP) 2002-284620

(51) Int. Cl. G21K 7/00

(52) U.S. Cl. 977/855

(57) ABSTRACT

A method for preparing a silver nano-structure by means of a scanning tunneling microscopy, which comprises using a probe being made of silver or having a surface coated with a thin silver film, and applying a voltage pulse to the probe, to thereby transfer a silver material from the probe onto the surface of a semiconductor substrate on a nano scale. The method allows the preparation with ease of a silver nano-structure exhibiting high electroconductivity and being optimal as a material for an electrode on an arbitrary place of a semiconductor substrate.

### TECHNICAL FIELD

The present invention relates to a method of producing a silver nano-structure by means of a scanning tunneling microscope. More specifically, the present invention relates to a method of producing a silver nano-structure by means of a scanning tunneling microscope, by which a nano-structure of silver adapted best to an electrode material having a high electric conductivity can easily be produced at an optional position on a semiconductor substrate.

### BACKGROUND ART

An electron-beam lithography method is a generally known method for producing nano-scale electrodes or dots on substrates. However, wires or gap structures of a size of 20 nm or less have not been produced by the electron-beam lithography method yet (for example, see non-patent document 1). The method using the electron-beam lithography involves complicated procedures, and thus a high-level technique has been required for high-precision production of electrode structures of a size of 50 nm or less.

Under such circumstances, the present invention has been made to achieve the object of providing a method of producing a silver nano-structure by means of a scanning tunneling microscope, by which a silver nano-structure adapted best to an electrode material having a high electric conductivity can easily be produced at an optional position on a semiconductor substrate. Non-patent document 1: Y. D. Park and the other five authors, “Comparative study of Ni nano-wire sputtered by electron-beam lithography and fabricated by lift-off and dry etching techniques,” J. Vac. Sci. Technol., volume B 18(1), January/February 2000, pp. 16-20.

### DISCLOSURE OF INVENTION

In order to achieve the object, there is provided according to the invention a method of producing a silver nano-structure by means of a scanning tunneling microscope, which comprises using a probe made of silver or a probe having a surface coated with a silver thin film in the scanning tunneling microscope and applying a voltage pulse to the probe so that silver is transferred on a nano-meter scale from the probe onto a surface of a semiconductor substrate (Claim 1).

In an aspect of the invention, the voltage pulse may be applied to the probe under the conditions of a voltage of ±3 V to ±10 V and a pulse width of 10 μs to 1 s (Claim 2).

The method of producing the silver nano-structure by means of the scanning tunneling microscope according to the invention is described below in more detail by means of examples.

### BEST MODE FOR CARRYING OUT THE INVENTION

As shown in the schematic diagrams of FIGS. 1(a) and 1(b), the method of producing the silver nano-structure by means of the scanning tunneling microscope according to the invention uses a probe made of silver (a silver probe) or a probe having a surface coated with a silver thin film (a silver thin film-coated prove) in the scanning tunneling microscope. A voltage pulse is applied to the probe so that silver is transferred on a nano-meter scale from the probe to the surface of a semiconductor substrate. Silver is transferred as follows. As shown in FIG. 1(a), the application of the voltage pulse causes electric-field-induced diffusion on the surface of the probe so that silver moves toward the tip of the probe. Consequently, the gap distance between the semiconductor substrate and the prove decreases and the intensity of the electric field increases so that the silver at the tip of the probe undergoes field evaporation to move toward the surface of the semiconductor substrate or makes point contact with the semiconductor substrate. In either case, silver is transferred onto the semiconductor substrate. Thereafter, as shown in FIG. 1(b), the probe moves upward so that a silver nano-dot is fixed on the surface of the semiconductor substrate.

In the method of producing the silver nano-structure by means of the scanning tunneling microscope according to the invention, therefore, an optional position on the semiconductor substrate can be searched or selected and subjected to the production of the silver nano-structure. The production of such a silver nano-structure cannot be achieved by the conventional electron-beam lithography method. For example, the production of such a silver nano-structure is achieved using a flutter position controller and a scan imaging mechanism, which are generally associated with the scanning tunneling microscope.

In the method of producing the silver nano-structure by means of the scanning tunneling microscope according to the invention, the silver nano-dot can be formed on a semiconductor substrate with a high probability. If optimal conditions, for example, a voltage of ±3 V to ±10 V and a pulse width of 10 μs to 1 s are selected for the application of voltage pulse to the probe, silver atoms can be transferred with a probability of almost 100% from the probe onto the surface of the semiconductor substrate. The probability of the silver nano-dot production is significantly higher than that of the gold nano-dot production using a gold probe, which can be up to about 50%. The silver nano-structure can be formed with higher efficiency, higher reproducibility and higher yield.

Thus, the silver nano-structure produced by the method of the invention allows the formation of a nano-dot(s) or a nano-wire(s), so that the simplifying the construction of nano-electronic circuits and achieving repairs of nano-electronic circuits are expected to be realized, because silver has a high electric conductivity and is adapted best to an optimal electrode material.

In the method of producing the silver nano-structure by means of the scanning tunneling microscope according to the invention, a wire or silver thin film with a purity of 98% or more may be selected as a material for the probe. When the silver wire is used for the probe, it is necessary to form a sharp probe tip. Such a sharp tip can be formed using direct cutting by electropolishing, with a nipper or the like, or using a focused ion beam process in which working is performed by applying a focused ion beam such as a gallium ion. On the other hand, when the surface of the probe is coated with silver thin film, for example, the probe whose surface is coated with a silver thin film may be produced by sputtering vapor deposition of a silver thin film on the surface of a tungsten probe formed by electropolishing.

### EXAMPLES

A silver probe and a silver thin film-coated probe were each prepared for a scanning tunneling microscope. The silver probe was formed of pure silver by twisting, pulling and cutting a wire of silver with a purity of 99.99% by means of a nipper. The silver thin film-coated probe was prepared by forming a silver thin film of 200 nm-thickness with a purity of 99.99% by DC-magnetron sputtering on a sharp-tip tungsten probe formed by electropolishing. A voltage pulse was applied to the prepared silver probe or silver thin film-coated probe so that the silver was transferred onto a semiconductor substrate, which was N-type silicon (111) and had a (7×7) surface structure reconstructed by ultra-high vacuum cleaning.

Referring to FIG. 1(a), the transfer of the silver is performed by a process including the steps of canceling the tunneling current feedback and applying a voltage pulse to the probe so that electric-field-induced diffusion occurred to promote the migration of the silver to the tip of the probe. As a result, the gap distance decreases and the intensity of the electric field increases to cause electric-field evaporation or point contact. In either case, the silver is transferred onto the semiconductor substrate. Thereafter, as shown in FIG. 1(b), the tunneling current feedback control is resumed so that the probe moves to an upper position so as to correct the decreased gap distance, and consequently a silver nano-dot adhering to the surface of the semiconductor substrate is fixed.

FIG. 2 is an STM (Scanning Tunneling Microscope) image (500 nm×500 nm) showing silver dots which were formed on the surface of the Si (111)-(7×7) substrate using the silver thin film-coated probe. The voltage pulse conditions included a pulse voltage of −3.5 V and a pulse width of 1 ms. As a result, silver nano-dots several nano-meters or less in diameter and height were formed with a high probability up to 92%. When the pulse voltage is at least ±4 V, the silver nano-dots are produced with a probability of almost 100%.

FIG. 3 is an STM image (1000 nm×1000 nm) showing a silver nano-wire which was formed on the surface of the Si (111)-(7×7) substrate using the silver thin film-coated probe. The voltage pulse conditions included a pulse voltage of −4.5 V and a pulse width of 1 ms. It is confirmed that silver dots can stably be produced in a continuous manner to form a wire at optional position.

FIG. 4 is an STM image (1000 nm×1000 nm) showing silver nano-letters which were formed on the surface of the Si (111)-(7×7) substrate using the silver thin film-coated probe. The voltage pulse conditions included a pulse voltage of −4.5 V and a pulse width of 1 ms. As shown in FIG. 3, it was possible to arrange dots at optional positions in the form of a continuous line, and thus nano-letters were formed as shown in FIG. 4. Therefore, it has rationally been concluded that not only letters but also more complicated patterns can be formed on a nano-meter scale and that the application of the process to nano-scale wiring is promising.

It will be understood that the above embodiments and examples are not intended to limit the scope of the invention. It will also be understood that the method of producing the probe of the scanning tunneling microscope, the detailed condition of the voltage pulse and the like may be in various specific modes.

### BRIEF DESCRIPTION OF DRAWINGS

FIGS. 1(a) and 1(b) are schematic diagrams showing the steps of the method of producing the silver nano-structure by means of a scanning tunneling microscope according to the invention, respectively;

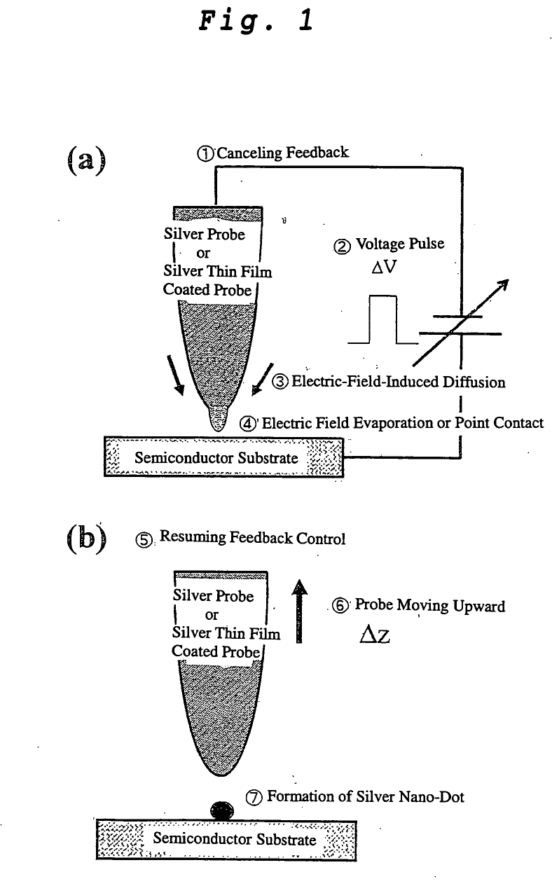

FIG. 2 is an STM image (500 nm×500 nm) showing silver nano-dots formed on the surface of the Si (111)-(7×7) substrate using the silver thin film-coated probe;

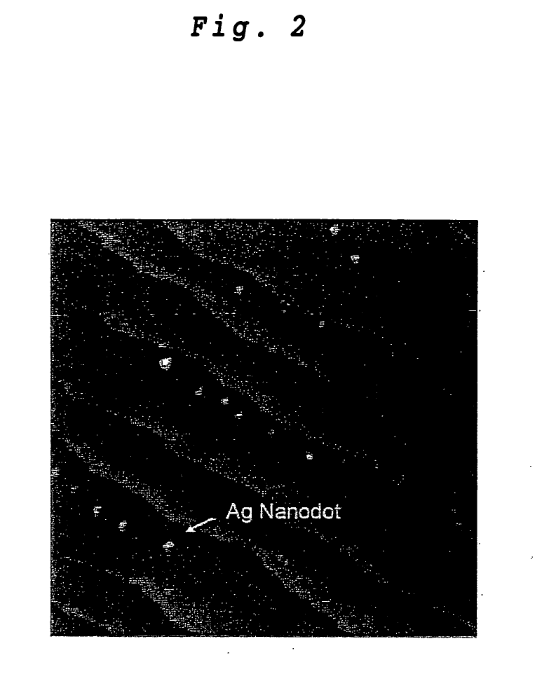

FIG. 3 is an STM image (1000 nm×1000 nm) showing a silver nano-wire formed on the surface of the Si (111)-(7×7) substrate using the silver thin film-coated probe; and

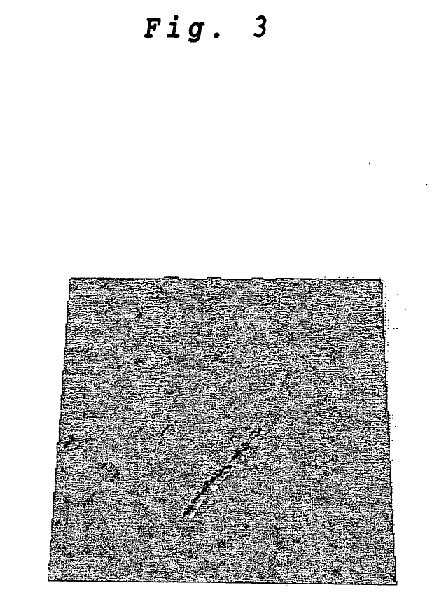

FIG. 4 is an STM image (1000 nm×1000 nm) showing silver nano-letters formed on the surface of the Si (111)-(7×7) substrate using the silver thin film-coated probe.

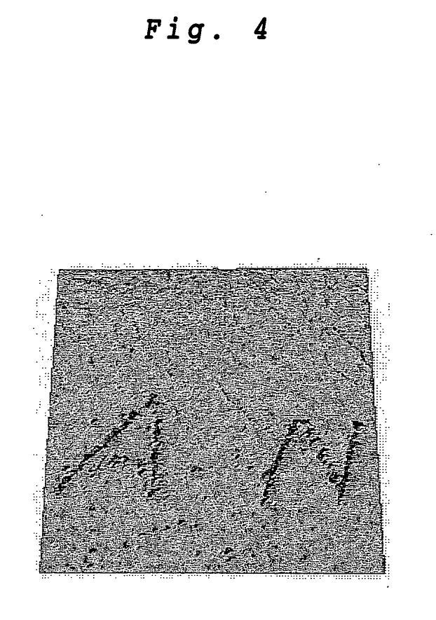

### INDUSTRIAL APPLICABILITY

As described above in detail, according to the present invention, nano-structures can easily be produced at optional position on a semiconductor substrate using silver which has a high electric conductivity and is a most suitable electrode material.

1. A method of producing a silver nano-structure by means of a scanning tunneling microscope, which comprises using a probe made of silver or a probe having a surface coated with a silver thin film in the scanning tunneling microscope and applying a voltage pulse to the probe so that silver is transferred on a nano-meter scale from the probe onto a surface of a semiconductor substrate.

2. The method of claim 1, wherein the voltage pulse is applied to the probe under conditions of a voltage of ±3 V to ±10 V and a pulse width of 10 μs to 1 s.
